(19) United States
(12) Patent Application Publication
(10) Pub. No.: US 2014/0199271 A1
(43) Pub. Date: Jul. 17, 2014

(54) METHOD FOR CONTROL OF DELETERIOUS MICROBES IN OIL AND GAS AND OTHER INDUSTRIAL FLUIDS

(71) Applicant: Multi-Chem Group, LLC, San Angelo, TX (US)

(72) Inventor: Edward Corrin, Houston, TX (US)

(73) Assignee: Multi-Chem Group, LLC, San Angelo, TX (US)

(21) Appl. No.: 13/740,696

(22) Filed: Jan. 14, 2013

(51) Int. Cl. A01N 63/00

(52) U.S. Cl. CPC A01N 63/00
USPC 424/93.6

(57) ABSTRACT

A method of controlling a deleterious bacteria in oil and gas production, oil and gas completion fluids or other industrial fluids is described which includes identifying a phage capable of infecting the deleterious bacteria, identifying a biocide compatible with the phage and effective against the deleterious bacteria and injecting the biocide and the phage into the oil and gas production, oil and gas completion or other industrial fluid.

### BACKGROUND

1. Field

The disclosure relates generally to the field of souring and microbiologically influenced corrosion in oil gas production and completion fluids, as well as other industrial waters. More specifically the disclosure relates to methods for introducing additives in these fluids to control souring and microbiologically influenced corrosion by deleterious microbes.

2. Background Art

Oil and gas production and completion fluids, as well as other industrial fluids, suffer corrosion, pipe necking (partial blockage) and scale buildup in pipes and pipelines. One source of these problems is microbially influenced corrosion (MIC) corrosion and bio-film blockages. Microbes may also negatively affect oil and natural gas recovery through bacterial fouling of the water needed to hydrofracture (“frac”) reservoir rock or to “water-flood,” to increase production of oil and gas. One particular type of microbe, sulfate reducing bacteria (SRB) can contaminate or “sour” the reservoir by producing hydrogen sulfide (H₂S). SRBs may produce toxic and flammable H₂S, which may shorten the lifetime of an piping and tankage, and introduce additional safety risks from drill rig to refinery. Acid producing bacteria (APB) produce acids, including sulfuric acid, which lead to additional corrosion. SRBs and APBs may have the same effects in other oil and gas completion fluids, as well as other industrial fluids.

### SUMMARY

In one embodiment of the present disclosure, a method of controlling a deleterious bacteria in oil and gas production, oil and gas completion fluids or other industrial fluids is described. The method includes identifying a phage capable of infecting the deleterious bacteria, identifying a biocide compatible with the phage and effective against the deleterious bacteria and injecting the biocide and the phage into the oil and gas production, oil and gas completion or other industrial fluid.

### DETAILED DESCRIPTION

The following disclosure provides many different embodiments, or examples, for implementing different features of various embodiments. Specific examples of components and arrangements are described below to simplify the present disclosure. These are, of course, merely examples and are not intended to be limiting.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

In the present disclosure, a synergistic combination of bacteriophages (phages) and biocides that are compatible with the phages but effective against deleterious bacteria is used in oil and gas production and completion fluids, as well as other industrial fluids, to control MIC and/or souring from bacteria.

Certain phages that are capable of lysing bacteria are natural viruses that infect, reproduce within, and kill bacteria. Phage infection of bacteria may be initiated when the tail proteins of the phage recognize and adsorb to specific cell surface features of the target bacterial host. This recognition triggers the injection of the phage DNA into the bacterial cytoplasm. The genes in that phage DNA result in the synthesis and assembly of approximately 20 to 100 progeny phage particles over the course of minutes to several hours. After as little as 15 to 60 minutes, the cell is disrupted (“lysed”) as a result of phage-encoded lytic enzymes, liberating of progeny phage that can adsorb to new bacterial hosts and repeat the process.

Phages for lysing bacteria have not been known to infect plants or animals and are therefore safe to produce, store, handle and apply. Phages reproduce along with the microorganisms that they infect, and therefore may spread down-well to other bacteria of the same species that otherwise would not be affected.

Unfortunately, deleterious bacteria may develop resistance to phages based on previous exposure or through natural selection. The resistance of the bacteria lessens the effectiveness of the phage, thereby increasing the rate and risk of MIC and souring. Initial treatment with the infective phage panel most often must be followed up by monitoring of the contained system to reveal the effects on the selected bacterial subpopulation. Over longer periods of time it may be necessary to alter the phages to address bacteria that have developed resistance mechanisms to the infective phages. Additionally, new bacterial species may begin to thrive in the absence of the initial selected bacterial subpopulation. Thus, the need may arise to alter the infective phage panel over time. The effectiveness of the infective phage panel may be monitored by evaluating changes in phage and bacterial host populations within the system. In such cases, it may be necessary to search for different phages to which the bacteria have not yet developed a resistance. Such a process can be time consuming and ultimately difficult after the deleterious bacteria have developed resistance to a number of different phages.

A number of different biocides have been developed for treating oil and gas and other industrial fluids to reduce the number of deleterious bacteria. However, typical industrial biocides are insufficient to completely sterilize systems. As a result, traditional biocide treatment techniques include continuous or follow up treatment of the biocide in order to control the bacteria to the appropriate level. Such continuous or follow up treatments are expensive.

In the present disclosure, a method is described that combines the use of a phage with a compatible biocide to increase the effectiveness of the phage together with reducing the number of applications of the biocide. The synergy between the phage and the biocide unexpectedly increases the effectiveness over either the phage or biocide by itself.

This disclosure addresses, in part, sulfur reducing bacteria (SRBs), as those bacteria are particularly problematic. However, as one of ordinary skill in the art will recognize with the benefit of this disclosure, the methods described herein may be used on other deleterious bacteria that may cause MIC and/or souring of oil and gas fluids, as well as other industrial fluids

Suitable Biocides

Useful biocides for the disclosed methods should be 1) suitable for controlling the deleterious bacteria and 2) compatible with the phage. Suitable biocides for controlling SRBs include, but are not limited to glutaraldehdye, quaternary amine compounds, and tetrakis (hydroxymethyl) phosphonium sulfate (THPS). In certain embodiments of the present disclosure, the amount of biocide in the fluid is between 10 ppm and 50,000 ppm active (by weight). In other embodiments, the amount of biocide in the fluid is between 25 ppm and 25,000 ppm active (by weight). Biocides should be evaluated for compatibility with the phage or phage panel selected.

In one embodiment of the present disclosure an infective phage panel against a selected bacterial subpopulation within the contained system and delivering to either a section of the system infected with the selected bacterial subpopulation or simulating the system in laboratory conditions a series of potentially infective phages or phage panels to reduce the selected bacterial subpopulation. An effective panel is one that is considered as effective at controlling the deleterious bacteria treatment. For instance, a phage or phage panel may be considered effective if it results in a bacterial concentration drop of 4 orders of magnitude, for example, from 10⁷ to 10⁸ cfu/mL down to 10³ to 10⁴ cfu/mL. Success in reducing a bacterial population may also be measured by reduction or abatement of pipe corrosion or pipe blockage without quantifying any remaining bacterial population. The process of identifying and developing the phage or phage panel is described further below.

Once the particular deleterious bacteria is identified, a panel of phages effective against the selected subpopulation of deleterious bacteria may be identified and manufactured. Phages exhibiting bacteriolytic activity against the bacterial subpopulation are most useful. However, phages are abundant and diverse—each phage type may only attack a specific bacterial hosts and may be harmless to non-host bacteria.

Phage panels may include pre-isolated phages (i.e., phages previously known to be effective against specific types of bacteria) as well as the isolation of phages from samples taken at industrial and environmental sites. Thus, in one embodiment of the present disclosure, the step of producing the infective phage panel may include screening and isolating naturally occurring phages active against the selected bacterial population.

As the predators of particular bacteria, populations of phages are most often abundant near the bacteria upon which they prey. Therefore, when isolating particular phages effective against deleterious bacteria in a particular system, identification of an environmental site where that bacterial type is abundant often the first step.

A sample for testing a particular phage or phage panel may be a marine or freshwater sediment from an environment favorable for the growth of the host bacteria. Physiochemical properties of the sediments other surrounding of the environment to be treated may also be considered. While exact parameters will vary from host to host and environment to environment, variables to consider include salinity, temperature, pH, nitrogen or eutrophication, oxygen, and specific organic compounds.

As an alternative to identifying samples based on physiochemical properties, molecular tools can be used to identify sediments possessing wild populations of bacteria similar to the target bacteria. These methods typically require purification of DNA from the environmental sample followed by the detection of marker DNA sequences.

Phages may be isolated by a number of methods including enrichment methods or any technique involving the concentration of phages from environmental or industrial samples followed by screening the concentrate for activity against specific host targets. Given the high genetic diversity of phages, naturally occurring phages will include those with novel genomic sequence as well as those with some percent of similarity to phages known to infect other bacterial clades.

Phages can be optimized for effectiveness. Optimization of phages is accomplished by selection for naturally occurring variants, by mutagenesis and selection for desired traits, or by genetic engineering. Traits that might be optimized or altered include, but not limited to, traits involved in host range determination, growth characteristics, improving phage production, or improving traits important for the phage delivery processes. Thus, in another aspect, the step of producing the infective phage panel includes creating engineered phages against the selected bacterial population. This will include phages created for having a broad host range. This may be the product of directed genetic engineering, for example.

Small amounts of the phage or phage panel are typically ineffective in a treatment fluid for controlling deleterious bacteria. As a result, phage or phage panels may be mass produced for treatment of a large system, such as surface equipment or subterranean formations. Phage may be produced using a liquid lysate method., as described in Meese, E. et al., (1990) Nucleic Acids Res., volume 18:1923, which is incorporated herein by reference. For instance, in one production method, an exponentially (=OD600˜0.3) growing stock of the target host is produced in the volume of liquid corresponding to the desired final lysate volume. This may be accomplished by inoculating the media from a stationary stage liquid culture to a very low (OD600˜0.01) and monitoring growth specrophotometrically until the desired OD is reached. The culture may be inoculated with virus to a moi (multiplicity of infection=ratio of virus particles to individual host cells) of 0.1 to 0.001. The culture may then be incubated until lysis is observed. The lysate may then be separated into phage and both bacterial cell debris and the components of the culture media such as through vacuum filtration. Tangential flow filtration will be used to replace components of the media with, for example, a 10 mM buffer, such as, but not limited to, a phosphate buffer, and, if necessary, to concentrate the virus. The final product is an aqueous solution containing the virus particles in a weak buffer with minimal bacterial cellular debris.

After isolating the phage and selecting the biocide, the system or formation may be treated to control the deleterious bacteria. Traditional methods for introducing the biocide and phage may be used. The phage and biocide may be mixed together and then introduced into the system or formation, or the phage and biocide may be introduced separately. For instance, in subterranean formations, the phage and biocide or phage/biocide mixture may be introduced as part of fracing or flooding operations. In surface systems, such as piping systems or other water systems, the phage and biocide or phage/biocide mixture may be injected into the system in effective amounts.

As will be recognized by one of ordinary skill in the art with the benefit of this disclosure, many types of deleterious bacteria groups may be controlled using the disclosed method. One group of bacteria commonly associated with MIC in petroleum pipelines are SRBs. SRBs reduce sulfates to sulfides, releasing sulfuric acid and hydrogen sulfide as byproducts that react with iron that may form a black precipitate of iron sulfide. Hydrogen sulfide gas is toxic and flammable and may cause souring of the petroleum product, resulting in reduced quality and increased handling cost. The term “SRB” is a phenotypic classification and several distinct lineages of bacteria are included under this umbrella term. Bacterial subpopulations involved in the microbial influenced biocorrosion process or the oilfield souring process include those that form the corrosive products and intermediate products of sulfate reduction, including, but not limited to, hydrogen sulfide. Such populations include those forming the taxonomically varied group known as the sulfate-reducing bacteria (SRB). Bacteria selected for virus treatment include members of the SRB including, including without limitation, are members of the delta subgroup of the Proteobacteria, including Desulfobacterales, Desulfovibrionales, and Syntrophobacterales. SRBs may develop complex sessile assemblages along with other species, in biofilms attached to the inner wall of the pipeline. Biofilm forming bacteria cause pipeline corrosion, production slowdown, product quality loss (souring), potential environmental hazards, and leaks.

Bacteria selected for phage treatment also includes those that produce acidic metabolites. This specifically includes sulfur-oxidizing bacteria capable of generating sulfuric acid. These bacteria include, without limitation, sulfur bacteria such as Thiobacilli, including T. thiooxidans and T. denitrificans. Bacterial populations and isolates selected for phage treatment further includes corrosion associated iron-oxidizing bacteria. Also included are isolates of the Caulobacteriaceae including members of the genus Gallionella and Siderophacus.

The combination of the phage with the biocide has a synergistic effect. As discussed above, bacteria become resistant to a phage or phage panel over time. However, the combination of the phage with the biocide significantly delaying this effect and prolonging the viability of the given phage or phage panel. Without being bound by theory, it is believed that the biocide acts to kill bacteria that may be resistant to the phage, thereby reducing the chances that a bacteria may become immune to the phage.

The various embodiments of the present disclosure can be joined in combination with other embodiments of the disclosure and the listed embodiments herein are not meant to limit the disclosure. All combinations of embodiments of the disclosure are enabled, even if not given in a particular example herein.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

While the foregoing is directed to embodiments, versions and examples of the present disclosure, which are included to enable a person of ordinary skill in the art to make and use the disclosures when the information in this patent is combined with available information and technology, the disclosure is not limited to only these particular embodiments, versions and examples. Also, it is within the scope of this disclosure that the aspects and embodiments disclosed herein are usable and combinable with every other embodiment and/or aspect disclosed herein, and consequently, this disclosure is enabling for any and all combinations of the embodiments and/or aspects disclosed herein. Other and further embodiments, versions and examples of the disclosure may be devised without departing from the basic scope thereof and the scope thereof is determined by the claims that follow.

1. A method of controlling a deleterious bacteria in oil and gas production, oil and gas completion fluids or other industrial fluids, the method comprising:
identifying a phage capable of infecting the deleterious bacteria;
identifying a biocide compatible with the phage and effective against the deleterious bacteria;
injecting the biocide and the phage into the oil and gas production, oil and gas completion or other industrial fluid.

2. The method of claim 1 wherein the biocide and phage are mixed prior to injection or are co-injected.

3. The method of claim 1 wherein the biocide is glutaraldehdye, a quaternary amine compound, or tetrakis (hydroxymethyl) phosphonium sulfate (THPS).

4. The method of claim 1 wherein the phage is adapted to reduce the concentration of deleterious bacteria by 4 orders of magnitude without the use of the biocide.

5. The method of claim 1 wherein the phage is isolated from an environment containing the deleterious bacteria.

6. The method of claim 1 wherein the phage is selected from phages known to be effective against the deleterious bacteria.

7. The method of claim 1 wherein phage is optimized by altering its host range determination, growth characteristics, or phage production.

8. The method of claim 1 wherein the deleterious bacteria is a sulfate-reducing bacteria (SRB).

9. The method of claim 8, wherein the biocide and phage are used to control SRBs in a fracing or flooding operation.
